(19) United States
(12) Patent Application Publication
(10) Pub. No.: US 2013/0103280 A1
(43) Pub. Date: Apr. 25, 2013

(54) Method for Determining a Vehicle Reference Speed and Brake System

(71) Applicants: Georg Roll, Heusenstamm (DE); Hans-Georg Ihrig, Darnstadt (DE); Dirk Wetzel, Huttenberg (DE)

(72) Inventors: Georg Roll, Heusenstamm (DE); Hans-Georg Ihrig, Darnstadt (DE); Dirk Wetzel, Huttenberg (DE)

(73) Assignee: Continental Teve AG & Co.oHG, Frankfurt (DE)

(21) Appl. No.: 13/808,339

(22) PCT Filed: May 11, 2011
(86) PCT No.: PCT/EP2011/057606

§ 371 Date: Jan. 4, 2013

(30) Foreign Application Priority Data
Jul. 6, 2010 (DE) 10 2010 030 984.2

(51) Int. Cl. B60T 8/1761

(52) U.S. Cl. CPC B60T 8/1761
USPC 701/74

(57) ABSTRACT

A method for determining a vehicle reference speed (VREF) in a brake system of amotorized single-track vehicle (201), of a type having an anti-lock control system (203). The slip control (204) can be carried out at one wheel (VR) of the motor vehicle depending on the vehicle reference speed (VREF). A sensor (202) for measuring the wheel speed (v) is arranged on this slip-controllable wheel (VR) and comprises the steps of forming a first wheel speed signal (v_{filt}_{_{—}}_{gradlim}) by low-pass filtering of the measured wheel speed (v). Wherein the negative gradient of the first wheel speed signal (v_{filt}_{_{—}}_{gradlim}) is limited to a predetermined gradient limit value (Δvₘₐₓ_{_{—}}ₙ/T), and that the first wheel speed signal (v_{filt}_{_{—}}_{gradlim}) is used as a wheel-specific vehicle reference speed (VREF, 3, 42, 62, 102, 110, 122, 123, 142) for slip control of the wheel (VR).

### CROSS-REFERENCE TO RELATED APPLICATION

This application claims priority to German Patent Application No. 10 2010 030 984.2, filed Jul. 6, 2011 and PCT/EP2011/057606, filed May 11, 2011.

### FIELD OF THE INVENTION

The invention relates to a method for determining a vehicle reference and a brake system for carrying out such a method.

### BACKGROUND OF THE INVENTION

Anti-lock brake systems (ABS) with electronic control are known in many designs and in the market. With most systems, the information required for control is obtained from measurement of the rotational behavior of the individual wheels, wherein by a logical combination of all wheel rotation signals, a vehicle reference speed approximately reproducing the vehicle speed is determined, which is then used as a reference parameter for determining the wheel slip and other control variables and then for dimensioning or control of the brake pressure in the wheel brakes.

It is also known, see e.g. DE 38 33 212 A1, to limit the gradient of the vehicle reference speed when forming the vehicle reference speed, in order to prevent physically impossible vehicle speed changes from contributing to the reference parameter generation.

The motorcycle has evolved over recent decades from a simply equipped means of transport to a recreational vehicle, for which the safety of the rider has increasingly come to the fore. Similarly to the case of automobiles some years ago, motorcycles are increasingly being equipped with anti-lock brake systems (ABS). From EP 0 548 985 B1, for example, an anti-lock device for motorcycles is known. Furthermore, a method for anti-lock braking of a motorcycle and for determining the coefficient of adhesion is known from DE 40 00 212 A1.

It is the object of the invention to provide a method for determining a reliable vehicle reference speed for the anti-lock control of a slip-controllable wheel of a motor vehicle, which can be implemented even in low-cost brake systems or in the event of a failure of the brake system.

The invention is based on the idea that for slip control of the wheel under consideration a wheel-specific vehicle reference speed is used, which is determined using only the wheel speed of this wheel. A first wheel speed signal is used as the vehicle reference speed, which is determined by low-pass filtering of the measured wheel speed and limiting the negative gradient of the filtered signal to a gradient limit value.

The gradient limit value is assumed to be positive here and thus indicates the maximum value of the negative gradient.

Under “wheel speed”, all those variables are to be understood which are directly related to the wheel speed, i.e. including wheel rotation times or wheel revolution rates.

An advantage achieved with the invention is that a reliable vehicle reference speed can be obtained for the anti-lock control of a wheel using only the wheel speed of this wheel. Accordingly, the invention can be used in low-cost brake systems, in which a wheel revolution rate sensor is only provided on the slip-controllable wheel. Likewise the invention can be used as an emergency measure in brake-by-wire brake systems, e.g. with electromechanical brakes. There a wheel-specific anti-lock control can be carried out by a wheel-specific control unit using the associated wheel speed only.

In order to prevent interference with the measured wheel speed signal and not to allow temporary wheel speed changes to affect the vehicle reference speed, the measured wheel speed is advantageously strongly filtered. A first order low-pass filter with a time constant of approx. 80 through approx. 100 ms is preferably used for the filtering.

According to a development of the invention, the gradient limit value for limiting the negative gradients of the vehicle reference speed is set to a predetermined initial value at the start of each slip control and then continuously adapted depending on the variation of the wheel speed during the anti-lock control. Particularly preferably, this predetermined initial value is not exceeded during the adaptation of the gradient limit value. The initial value for the magnitude of the negative gradient is particularly preferably 1 g (g: acceleration due to gravity).

For adaptation of the gradient limit value, a second wheel speed signal is preferably formed, which is compared with the first wheel speed signal for determining a deceleration value. Depending on the deceleration value determined, an adapted gradient limit value is determined. Particularly preferably, the new gradient limit value is set equal to the determined deceleration value.

According to a preferred embodiment of the invention, the second wheel speed signal is provided by the unfiltered signal of the measured wheel speed. Thus no further filter or similar is required.

According to another preferred embodiment of the invention, the second wheel speed signal is determined by low-pass filtering of the measured wheel speed. The filter constant of the low-pass filtering of the second wheel speed signal is smaller than the filter constant of the low-pass filtering of the first wheel speed signal. Particularly preferably, the filter constant for the second wheel speed signal is approx. 30 through 40 ms. By taking into account a weakly filtered wheel speed signal as a second wheel speed signal, random influences on the determination of the deceleration value by oscillations of the wheel speed can be prevented.

The deceleration value preferably represents a mean vehicle deceleration and is thus determined by a time duration and an associated speed difference of the first wheel speed signal, i.e. the vehicle reference speed.

Preferably, for adaptation of the gradient limit value, a second wheel speed signal is formed, which is compared with the first wheel speed signal for determining a deceleration value. Depending on the determined deceleration value, an adapted gradient limit value is determined. Particularly preferably, the new gradient limit value is set equal to the determined deceleration value.

In a preferred embodiment, the duration is determined by the time interval between first and second operating points and the associated speed difference as the speed change of the first wheel speed signal between the first and the second operating points. The first operating point corresponds to the point of identification of wheel instability. Wheel instability of the wheel is particularly preferably identified when the slip of the wheel exceeds a slip threshold or if there is a pressure decrease at the wheel resulting from the anti-lock control. The second operating point corresponds particularly preferably to a point at which the wheel instability is essentially compensated. The deceleration value calculated using these operating points thus corresponds to a mean vehicle deceleration during the control of the wheel instability. The associated adapted gradient limit value is advantageously smaller than the previous gradient limit value.

According to a preferred embodiment of the method according to the invention, the second operating point corresponding to the first operating point is identified when the second wheel speed signal decreases following control of the wheel instability, so that the second wheel speed signal intersects the first wheel speed signal. Particularly preferably, this point of intersection of the second and first wheel speed signals is a trigger criterion for a pressure build-up by the anti-lock control.

In cases in which there is no suitable point of intersection of the first and second wheel speed signals as described above, the second operating point associated with the first operating point is preferably then identified if the first and the second wheel speed signals differ for a predefined duration by no more than a predetermined speed value. Particularly preferably, the predetermined duration is approx. 40 through 60 ms. The predetermined maximum speed value is advantageously approx. 3 km/h.

In order to avoid under-braking of the vehicle, the gradient limit value for limiting the first wheel speed signal is preferably increased during a pressure build-up phase of anti-lock control of the wheel. The gradient limit value is increased for this purpose by an amount proportional to the pressure increase at the wheel in the pressure build-up phase.

Preferably, the anti-lock control is carried out in a digital anti-lock controller, i.e. the controller operates in a time-discrete manner and processes the corresponding variables in fixed, uniform time intervals (loop time).

Likewise, it is preferred that the first wheel speed signal, the second wheel speed signal and the gradient limit value are determined again after each loop time of the controller.

According to one development of the invention, an intersection of the second and first wheel speed signals is identified if the first and the second wheel speed signals are identical during a loop time or if a change has occurred as to which of the two signals is greater than the other signal when comparing the current loop time to the previous loop time.

Preferably, the method according to the invention is implemented in a brake system of a motorized single-track vehicle, wherein in this case the gradient limit value for limiting the first wheel speed signal of the slip-controlled wheel, e.g. a front wheel, is adapted depending on a signal of a brake light switch for the other wheel, e.g. a rear wheel. Particularly preferably, the gradient limit value is increased by a predetermined amount, if during front wheel-anti-lock control the rear wheel brake light switch signal changes from “inactive” to “active”, and reduced by a predetermined amount if during a front wheel-anti-lock control the rear wheel brake light switch signal changes from “active” to “inactive”.

Preferably, a method according to the invention is implemented in a brake system of a single-track vehicle, which is designed so that slip control can only be carried out on one of the two wheels, especially the front wheel, and with which a sensor for measuring the wheel speed is only arranged on the slip-controllable wheel.

Likewise, it is preferable that a method according to the invention is implemented in a brake system of a single-track vehicle, which is designed so that slip control can be carried out on both wheels, whereby a sensor for measuring the wheel speed is arranged on both wheels. Advantageously, in certain situations a wheel-specific vehicle reference speed is determined for each of the two wheels and slip control is carried out on each of the two wheels depending on the respective wheel-specific vehicle reference speed.

Furthermore, a method according to the invention is preferably implemented in a brake-by-wire brake system, in which, e.g. in an emergency mode, slip control of the respective associated wheel is carried out by wheel-specific brake controllers, which e.g. are associated with each wheel depending on the corresponding wheel-specific vehicle reference speed. Particularly preferably, the brake-by-wire brake system comprises electromechanical brakes.

The invention also relates to a brake system, in which an already described method is implemented.

### BRIEF DESCRIPTION OF DRAWINGS

Further preferred embodiments of the invention are derived from the dependent claims and the following description using figures.

The figures show schematically:

FIG. 1 shows example signal profiles during ABS control on a smooth road,

FIG. 2 shows example signal profiles during ABS control on a road with a sudden reduction in coefficient of friction,

FIG. 3 shows example signal profiles during ABS control on a road with a sudden increase in coefficient of friction,

FIG. 4 shows example signal profiles from the start of ABS control on a road with a low and a high coefficient of friction,

FIG. 5 shows example signal profiles from the start of ABS control for two different vehicle reference speeds,

FIG. 6 shows example signal profiles from the start of ABS control with a further auxiliary signal, and

FIG. 7 shows a motorcycle suitable for implementing a method according to the invention.

### DETAILED DESCRIPTION OF THE INVENTION

The principle of anti-lock control (ABS control) provides for a decrease in the brake pressure of a controlled wheel if wheel over-braking or wheel instability occurs, whereby this is identified from a high degree of brake slip and high wheel deceleration. Following a suitable decrease in wheel brake pressure and the resulting acceleration of the wheel in the stable slip region, the brake pressure of the wheel is again increased stepwise until there is again visible wheel instability. This cyclic pressure build-up and decrease is repeated until the vehicle comes to rest or the driver reduces the brake pressure below the locking pressure level. The principle of pressure reduction and pressure build-up for the control of wheel slip is known.

In order to find optimal wheel pressure values even in the event of fluctuating road coefficients of friction, wheel slip and wheel acceleration are carefully analyzed, so that the tendency towards wheel locking can be reliably identified. The wheel slip is calculated in so doing using the so-called vehicle reference speed (VREF), because the actual vehicle speed cannot be measured without a high level of complexity and is thus generally unknown to the brake controller. For accurate assessment of the wheel stability, the vehicle reference speed VREF used should therefore approximate to the actual vehicle speed as well as possible. If the vehicle reference speed VREF is too high, an excessive slip is assumed and sometimes pressure can decrease too soon, which can cause under-braking.

If the assumed vehicle reference speed VREF is too low, the slip that is erroneously calculated as too low leads to an excessively high wheel stability value, which can cause wheel over-braking leading to instability.

Therefore, a method for forming a reliable vehicle reference speed using only a single wheel revolution rate signal is proposed.

For example, the method is implemented for calculating or estimating a vehicle reference speed in an electronic controller for a 1-channel anti-lock system for motorized single-track vehicles, e.g. motorcycles and motor scooters. Only the brake pressure of the front wheel VR is controlled with one channel based on the hydraulic and electrical configuration of the brake system. Furthermore, e.g. for cost reasons, only the wheel revolution rate of the front wheel VR is recorded using sensors. The calculation and estimation of the vehicle reference speed VREF for the ABS control of the front wheel VR therefore takes place only on the basis of the revolution rate information for the front wheel VR.

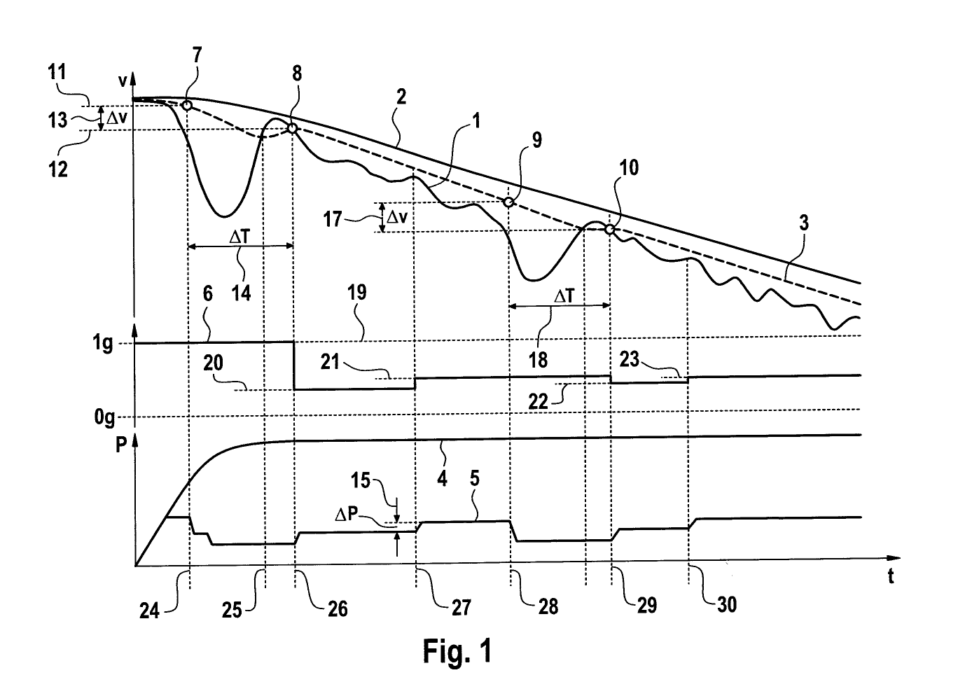

FIG. 1 shows example signal curves schematically during ABS control on a smooth road. Using the signal curves, an example method is explained below. The time variation of the wheel speed v of the front wheel VR is illustrated by curve 1; curve 2 gives the (actual) vehicle speed. Line 3 reproduces an estimated vehicle reference speed VREF. Curve 4 gives the brake pressure controlled by the driver (upstream pressure) and curve 5 the wheel brake pressure P at the controlled front wheel VR.

For example, the measured wheel speed 1 of the front wheel VR is relatively strongly filtered, e.g. with a first order low-pass filter and a time constant of approx. 80 through 100 ms. The resulting signal v_{filt} is considered as a first approximation to the vehicle speed:

v_{filt}_{_{—}}ₙ=((k−1)*T*v_{filt}_{_{—}}ₙ₋₁+T*vₙ)/(k*T)

or after reducing the loop time T

v_{filt}_{_{—}}ₙ=((k−1)*v_{filt}_{_{—}}ₙ₋₁+vₙ)/k

with
v_{filt}_{_{—}}ₙ: filtered wheel speed in the current control loop,
v_{filt}_{_{—}}ₙ₋₁: filtered wheel speed in the previous control loop,
vₙ: wheel speed in the current control loop,
T: loop time of the, in particular digital, ABS controller (e.g. 10 ms), and
k*T: time constant of the low-pass filter (e.g. 80 ms, i.e. k=8 for T=10 ms).

If the driver specifies a brake pressure 4 that is too high during braking, then the ABS controller sets a wheel brake pressure 5 by suitable activation of control valves that prevents locking of the wheel VR. However, for safety reasons the cyclic modulation of the wheel pressure 5 regularly causes brief over-braking of the wheel with instability for a certain period ΔT (e.g. time interval between the time points 24 and 26 or 28 and 29).

In order that in the event of such a wheel instability the filtered signal v_{filt} does not follow the steeply decreasing wheel speed 1 too strongly (this cannot be prevented by a filter), the negative gradient of the filtered signal, for example, is limited to a maximum value of Δvₘₐₓ, which is continually adapted during ABS braking.

The filtered and gradient limited signal is denoted by v_{filt}_{_{—}}_{gradlim}. In the nth control loop the gradient-limited filtered speed v_{filt}_{_{—}}_{gradlim}_{_{—}}ₙ is defined as the maximum of the filtered wheel speed v_{filt}_{_{—}}ₙ and the difference of v_{filt}_{_{—}}ₙ₋₁ and Δvₘₐₓ_{_{—}}ₙ according to the following equation:

v_{filt}_{_{—}}_{gradlim}_{_{—}}ₙ=max(v_{filt}_{_{—}}ₙ,(v_{filt}_{_{—}}ₙ₋₁−Δvₘₐₓ_{_{—}}ₙ))

Thus if the filtered signal v_{filt}_{_{—}}ₙ is smaller than the filtered signal of the previous loop v_{filt}_{_{—}}ₙ₋₁ reduced by the gradient Δvₘₐₓ_{_{—}}ₘ then v_{filt}_{_{—}}_{gradlim}_{_{—}}ₙ is set to the value v_{filt}_{_{—}}ₙ₋₁−Δvₘₐₓ. A stable reference signal v_{filt}_{_{—}}_{gradlim} is obtained in this way, which is directly based on the one available wheel speed 1 on the one hand; on the other hand, however, it does not follow the high negative gradient that can occur at the wheel VR but not as a vehicle deceleration. In FIG. 1 the vehicle reference speed VREF or v_{filt}_{_{—}}_{gradlim determined according to the above calculation method is illustrated as a dashed signal 3, which lies somewhat below the actual vehicle speed 2.}

In order that the signal v_{filt}_{_{—}}_{gradlim}_{_{—}}ₙ is reliable as the reference speed VREF, e.g. the limiting gradient Δvₘₐₓ_{_{—}}_{n/T} in each control loop of length T or the maximum speed change Δvₘₐₓ_{_{—}}ₙ per loop is suitably calculated. In doing this, the maximum speed change Δvₘₐₓ_{_{—}}ₙ is set to a value in each case that is slightly above the actual vehicle speed decrease Δv_{Fzg}_{_{—}}ₙ per loop based on the actual vehicle deceleration, i.e. the following applies:

Δvₘₐₓ_{_{—}}ₙ>Δv_{Fzg}_{_{—}}ₙ

An example curve of the limiting gradient Δvₘₐₓ_{_{—}}ₙ/T is illustrated in FIG. 1 as signal 6.

The calculation of the speed changes Δvₘₐₓ_{_{—}}ₙ takes place, for example, according to the following. Outside of or at the start of ABS control, it is assumed that the maximum conceivable coefficient of friction, i.e. the value 1, exists (level 19 of signal 6), so that the vehicle can be decelerated during full braking at about the acceleration due to gravity 1 g. This assumption is necessary because as yet there are not sufficient measurement values for a reliable estimate, and the maximum physically possible vehicle deceleration must be assumed on safety grounds, in order to avoid under-braking of the vehicle as a result of too high an estimated reference speed VREF. Accordingly, the maximum speed change is calculated according to

Δvₘₐₓ_{_{—}}ₙ=1g*T

(with T: control loop time).

In the first phase of the wheel instability from time 24 through 26, this means that the estimated vehicle reference speed 3 follows the wheel speed 1 with a maximum deceleration of 1 g in slip. By suitable modulation of the wheel pressure 5, the wheel VR is again accelerated towards vehicle speed 2. Because signal 3 was estimated too low, wheel speed 1 exceeds signal 3 at time 25 and raises it again above the filter function mentioned until time 26, so that a new intersection point 8 of signals 1 and 3 occurs.

In the example, a new value 20 for the limiting gradient Δvₘₐₓ_{_{—}}ₙ/T (signal 6) is now calculated, because the speed difference Δv (value 13) divided by the time ΔT (value 14) represents a good measure of the mean vehicle deceleration during time interval ΔT. In addition, Δv is calculated by storing value 11 of the vehicle reference speed VREF (signal 3) if a wheel instability (operating point 7) is identified. Value 12 of the vehicle reference speed VREF at the signal intersection point 8 is subtracted from this value 11, and value 13 for Δv is the result. For the calculation of ΔT, time 24 of point 7 is subtracted from time 26 of point 8. The quotient of Δv and ΔT is the mean vehicle deceleration during time interval ΔT:

a_{Fzg}=Δv/ΔT

From this we get the actual limiting gradient

Δvₘₐₓ_{_{—}}ₙ/T according to

Δvₘₐₓ_{_{—}}ₙ/T=a_{Fzg}

The new deceleration value 20 determined in this way is smaller than the previous value 19, because during time period 14 of wheel instability there is no increase in deceleration as a result of the braking situation of the wheel VR under consideration.

In order not to set the vehicle reference speed VREF at too high a level, the deceleration value is adapted again in the pressure build-up phase in the example. An increased vehicle deceleration can then only be expected if the wheel brake pressure 5 were to be increased (times 26 and 27 as well as 29 and 30 in FIG. 1). Therefore the limiting gradient 6 in the example is increased in each case by an amount Δa_{Fzg}, which is proportionally calculated from the corresponding pressure increase ΔP (e.g. value 15 at time 27):

Δvₘₐₓ_{_{—}}ₙ/T=Δvₘₐₓ_{_{—}}ₙ₋₁/T+Δa_{Fzg}

with Δa_{Fzg}=K*ΔP

The factor K results from the effect of the brakes and is assumed to be known. For example, the deceleration of a motorcycle increases by 0.6 m/s² if the front wheel pressure rises by 3 bar. For this purpose, the factor K then results according to

K=Δa_{Fzg}/ΔP=0.6 m/s²/3 bar=0.2 m/s²/bar

The value of the factor K can vary with the load on the vehicle and the quality of the brakes, therefore it is advantageous to adaptively select the value of the factor using other information (load state of the single-track vehicle, the condition of the brake disks etc.).

If no brake pressure sensor is provided in the brake system for determining the pressure increase ΔP, the value ΔP is estimated in the example using the valve activities. In the example of FIG. 1, in time interval 18 a further wheel instability is controlled, so that an analogous procedure for calculating the limiting gradients takes place on the basis of the operating points 9 and 10, as described above using operating points 7 and 8. The limiting gradient 6 is reduced at time 29 from the higher value 21 to the lower value 22 and is increased to value 23 again at time 30 because of a new pressure build-up.

The method according to the example thus provides for the determination of a reliable new value for the VREF limiting gradient in the instability phase of wheel VR, in which an ABS pressure decrease takes place, and for a slight increase of this for each further build-up of the wheel pressure 5.

Fundamentally, the limiting gradient 6 should be determined to be too large rather than too small, as can be seen from the example in FIG. 1. Therefore under-braking of the vehicle is reliably prevented. Because the ABS control means assesses not only the wheel slip but also the wheel deceleration, over-braking can be prevented for the following reasons. If the real slip of the braked wheel VR is too high, the adhesion between tire and road surface changes to sliding friction. This results in a positive feedback effect from the control technology viewpoint (self-reinforcing effect) along with the tendency towards locking. This effect leads to a very abrupt deceleration of the wheel VR. If the wheel deceleration is additionally assessed, the method of VREF estimation in the example always leads to a sufficiently good identification of the optimum braking point, at which the wheel pressure is then to be reduced again. It is also helpful that motorcycles can in any case only be braked on surfaces on which a safe driving mode is also guaranteed. This excludes extremely low coefficients of friction, such as can occur on ice or slippery snow, and it is ensured that no extreme effects are possible, as can partly occur with automobiles, such as, for example, at least temporary vehicle acceleration during downhill braking on very slippery surfaces.

Motorcycles frequently comprise a rear wheel brake that is independent of the front wheel brake, whose braking effect has an influence on the braking deceleration, e.g. if the driver varies the brake pressure at the rear wheel during ABS-control of the front wheel. According to one example embodiment of the invention, at least one brake light switch (HR-BLS-signal) of the rear wheel circuit is thus included in the said method as an indication of rear wheel braking. For example, when the HR-BLS-signal changes from “inactive” to “active” during front wheel ABS control, the limiting gradient Δvₘₐₓ_{_{—}}ₙ/T for the vehicle reference speed is increased by a percentage value or it is decreased by a percentage value when the HR-BLS-signal changes from “active” to “inactive”.

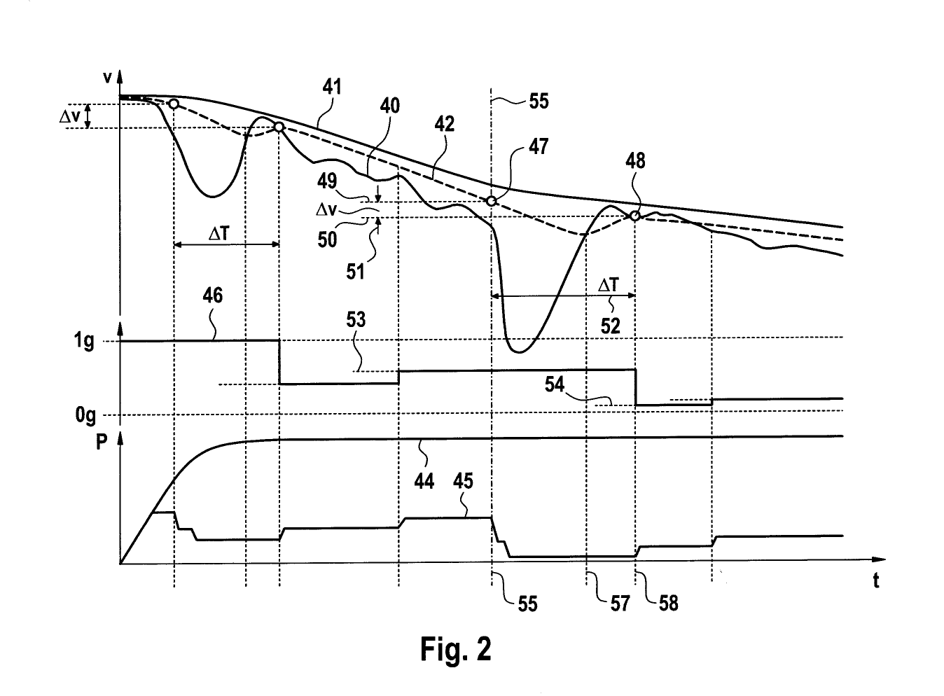

FIG. 2 schematically shows signal profiles in the example for braking on a surface whose coefficient of friction decreases abruptly during ABS-control at time 55. The variation of the wheel speed of the front wheel VR against time is illustrated by curve 40; curve 41 indicates the vehicle speed. Line 42 reproduces the estimated vehicle reference speed VREF. Curve 44 reproduces the brake pressure (upstream pressure) controlled by the driver and curve 45 reproduces the wheel brake pressure on the controlled front wheel VR. Signal 46 reproduces the limiting gradient Δvₘₐₓ_{_{—}}ₙ/T.

As a result of the abrupt change in coefficient of friction there is a strong tendency towards wheel locking from time 55, which can be detected at the deep slip onset of wheel speed 40. In order to compensate for this, the wheel pressure 45 is significantly reduced relative to the excessive upstream pressure 44 applied by the driver during time interval 52. Because the VREF limiting gradient 46 was previously at a high value 53, the vehicle reference speed signal 42 passes into slip too steeply between times 55 and 57 and therefore deviates significantly from the actual vehicle speed 41. But the vehicle reference speed is corrected again by the acceleration of the wheel VR during time interval 57 through 58. At the intersection point 48 of the vehicle reference speed 42 with the wheel speed 40, for the limiting gradient 46 according to the method described above the smaller value 54 is determined again, because the vehicle deceleration was only low over a relatively long time interval 52 and thus only the small decrease 51 in the vehicle speed (Δv) occurred. This is the difference of speeds 49 and 50 at Operating points 47 and 48. The small value 54 for the signal 46 results from the small quotient Δv/ΔT (according to the above formula Δvₘₐₓ_{_{—}}ₙ/T=a_{Fzg}=Δv/ΔT).

The example illustrated in FIG. 2 shows that the method in the example also rapidly determines reliable maximum values for the VREF gradients for coefficient of friction transitions from high to low values. After time 58 this ensures that the vehicle reference speed 42 decreases very gradually, i.e. is held at a high level, which is advantageous in view of the low road surface coefficient of friction.

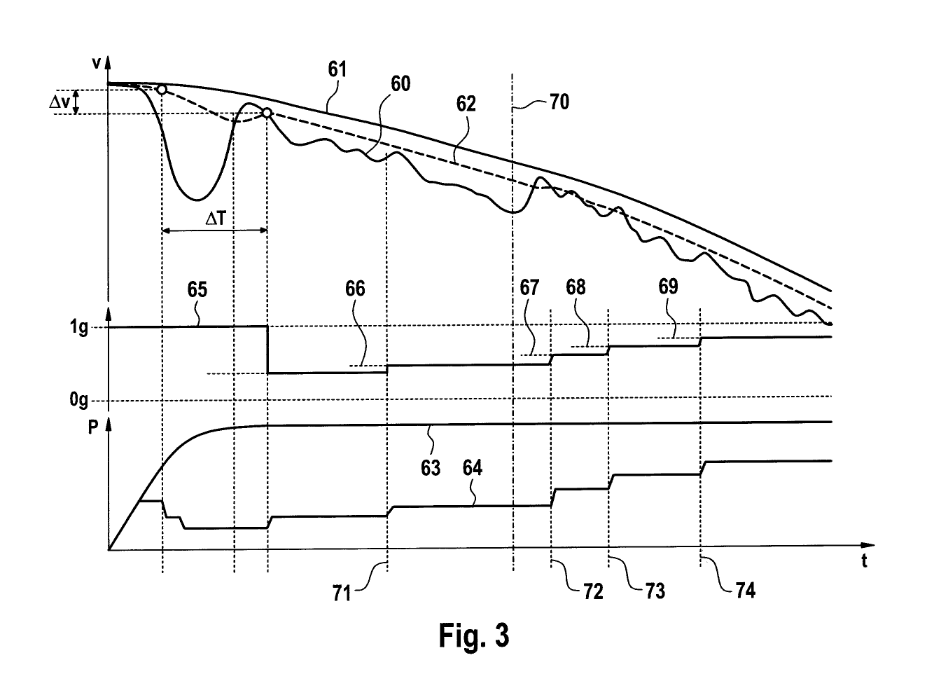

FIG. 3 shows schematically signal profiles in the example for braking on a surface whose coefficient of friction increases abruptly during ABS-control at time 70. The variation with time of the wheel speed of the front wheel VR is illustrated by curve 60; curve 61 represents the vehicle speed. Line 62 reproduces the estimated vehicle reference speed VREF. Curve 63 reproduces the brake pressure (upstream pressure) controlled by the driver and curve 64 represents the wheel brake pressure on the controlled front wheel VR. Signal 65 reproduces the limiting gradient Δvₘₐₓ_{_{—}}ₙ/T.

Following the abrupt change in the coefficient of friction, the tendency towards locking of the ABS controlled wheel VR reduces significantly, which can be detected from the stable varying wheel speed 60. Accordingly, the level of the wheel pressure 64 stepwise approaches the upstream pressure 63 demanded by the driver at times 72, 73 and 74. The vehicle deceleration therefore increases and the actual vehicle speed 61 tends more strongly to zero. By the method in the example, with each build-up of the wheel pressure ΔP the VREF limiting gradient 65 increases stepwise to the values 67, 68 and 69, so that the vehicle reference speed 62 follows the wheel speed 60 more steeply in each case. The method in the example is also suitable, for example, to guarantee useful vehicle reference speed estimates in the event of increasing road surface coefficients of friction.

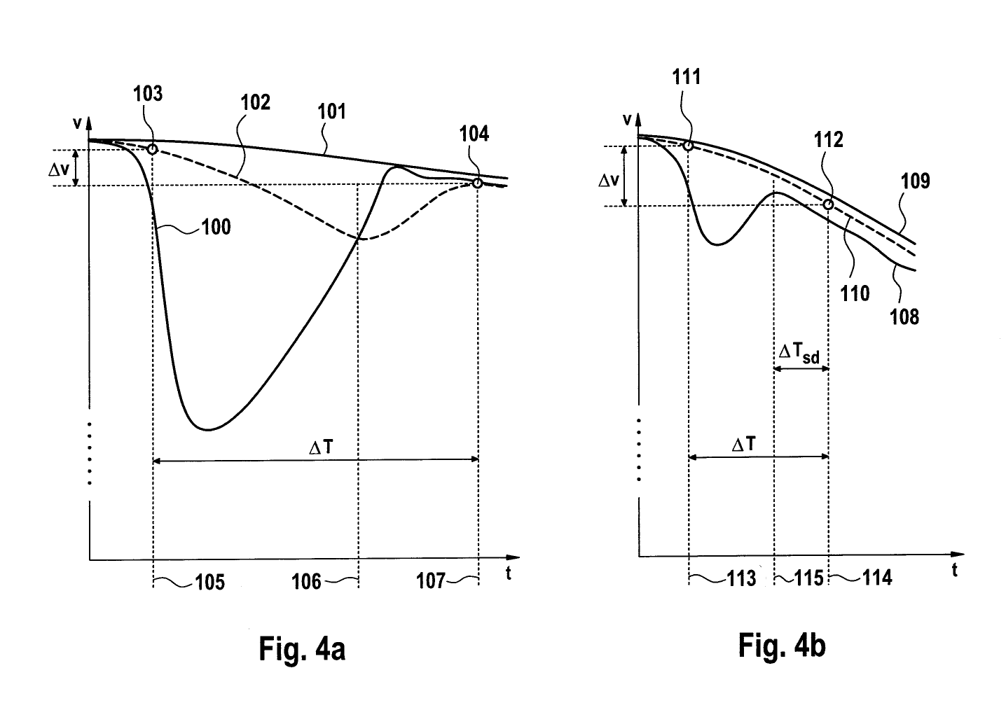

FIG. 4 shows schematically two other examples for calculating a VREF limiting gradient during wheel instability.

In FIG. 4a signal profiles in the example for braking at low coefficients of friction are illustrated schematically. The variation with time of the wheel speed of the front wheel VR is illustrated by curve 100; curve 101 represents the vehicle speed. Line 102 reproduces the estimated vehicle reference speed VREF. Similarly, as explained using the example illustrated in FIG. 2, the vehicle reference speed 102 first runs far too steeply into slip and thus deviates significantly from the actual vehicle speed 101. After time 106, the vehicle reference speed 102 is increased again by the wheel speed 100 using the filter function. After the crossing point at time 106, there is another crossing of the signals at time 107 at the operating point 104. A new VREF limiting gradient is thus formed here using the quotient Δv/ΔT in the example.

In such cases—primarily for reasons of stable ABS control—it must be ensured that the pressure on the controlled wheel VR is reduced at least so strongly that the wheel speed 100 returns to the vehicle speed 101. In the event of too early a pressure build-up (i.e. before time 106), the wheel VR would remain in slip, so that an instability could occur. This can be prevented by a suitable design of the ABS control strategy, so that the method in the example for determining the vehicle reference speed VREF also produces reliable results in these cases. Likewise, a reduction of the road surface coefficient of friction at close to time 106 could cause the wheel speed 100 not to return to the vehicle speed 101. In each case the ABS control could ensure by a suitable pressure decrease that such situations at least do not occur for long periods.

In FIG. 4b signal profiles in the example for braking on a road surface with a high coefficient of friction are illustrated schematically. The variation with time of the wheel speed of the front wheel VR is illustrated by curve 108; curve 109 represents the vehicle speed. Line 110 reproduces the estimated vehicle reference speed VREF. Because the vehicle is already strongly decelerated during the first time interval 113 through 114 of the ABS control, the wheel speed 108 does not increase above the vehicle reference speed 110. There is therefore no crossing point of signals 108 and 110, with which a determination of quotient Δv/ΔT takes place according to the method explained above. In this case it will be checked in the example whether the wheel speed 108 remains close to the vehicle reference speed 110 within a specific time interval ΔT_{sd}, i.e. e.g. the difference of the two signals 108, 110 is small (e.g. less than 3 km/h) for a sufficiently long time period of e.g. approx. 50 ms. Then after expiry of the time interval ΔT_{sd}, i.e. at time 114, the operating point 112 is defined as the current vehicle reference speed. From time 113 of the identified wheel instability (operating point 111) and time 114, a quotient calculation according to Δv/ΔT is then possible, and a VREF limiting gradient can be determined.

The variation of the vehicle reference speed depends on the filtering of the wheel speed. However, the intersection points between the vehicle reference speed VREF and the wheel speed in the example can thus also vary with the filtering, which in turn leads to different results in the determination of the operating points for determining the quotient Δv/ΔT.

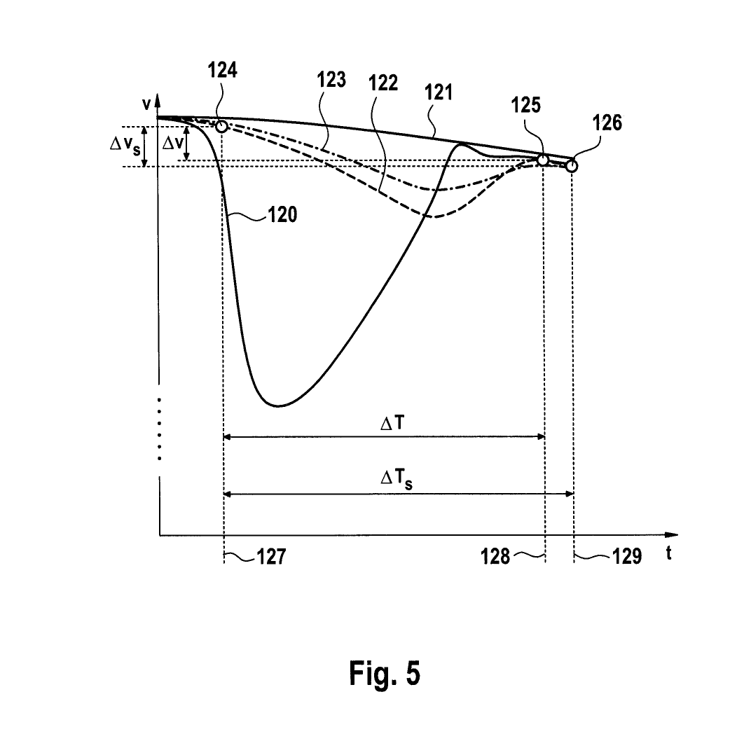

For illustration of this relationship, a comparative example for two different filter constants is illustrated in FIG. 5. The signal 120 represents the wheel speed, from which a vehicle reference speed is formed by filtering and gradient limiting in the example. Signal 122 shows the vehicle reference speed for weaker filtering; signal 123 shows the vehicle reference speed for the case of stronger filtering. Signal 121 reproduces the actual vehicle speed.

The vehicle reference speed for the weaker filtering (122) follows the wheel speed 120 more quickly than is the case for the stronger filtering (123). Because this is the case in both directions, however, i.e. both during deviation from and during the approach to the vehicle speed 121, approximately the same results occur for the quotient determination Δv/ΔT. In the weaker filtering case an earlier intersection point 125 of the signals occurs at time 128; in the stronger filtering case the intersection point 126 only occurs at the later time 129. The somewhat extended time interval ΔTₛ for the stronger filtering case is generally compensated, however, by a likewise somewhat larger speed difference Δvₛ.

It has been shown that the filter constant can vary within a large range, without the results being significantly different. If the filter constant is nevertheless chosen to be too large, then the vehicle reference speed only follows the actual vehicle speed poorly in situations with fluctuating coefficients of friction. Thus, advantageously, a value of 100 ms is not exceeded as a limit for the filter time constant.

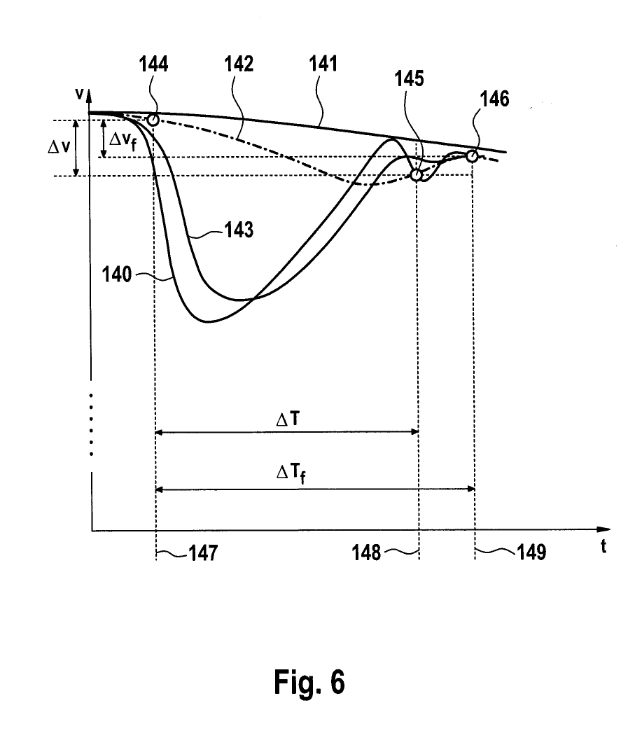

In FIG. 6 signal profiles in the example are schematically illustrated, using which it should be indicated which difficulties can occur, if the unfiltered wheel speed of the front wheel VR is used for the method in the example. The variation with time of the wheel speed of the front wheel VR is illustrated by curve 140; curve 141 represents the vehicle speed and line 142 reproduces the estimated vehicle reference speed VREF.

Because of oscillations in the wheel speed 140 after compensation of the tendency towards locking, a crossing point 145 occurs between the vehicle reference speed 142 and the wheel speed 140 at a relatively early time 148 and at quite a low speed level. As the example shows, the position of the crossing point 145 is caused somewhat randomly by the strong oscillations in the wheel speed 140. Such oscillations can, however, occur very easily during ABS control. In order to make the results of the gradient limiting of the vehicle reference speed reproducible, it is proposed in the example that not the actual wheel speed 140 but a weakly filtered wheel speed 143 is used. The filter time constant used here lies significantly below the filter time constant for the vehicle reference speed calculation, i.e. at approximately 30 through 40 ms, for example.

As shown in FIG. 6, the weakly filtered wheel speed 143 leads to a crossing point 146, which is at a later time 149 and at a higher speed level. The quotient Δv_{f}/ΔT_{f} determined from this leads to a significantly better result for the gradient limiting of the vehicle reference speed than the excessive quotient Δv/ΔT from the crossing point 145.

It has been shown that by the measure of weak filtering of the wheel speed, the probability of a faulty calculation of the vehicle deceleration during an instability phase of the anti-locking controlled wheel VR is significantly reduced.

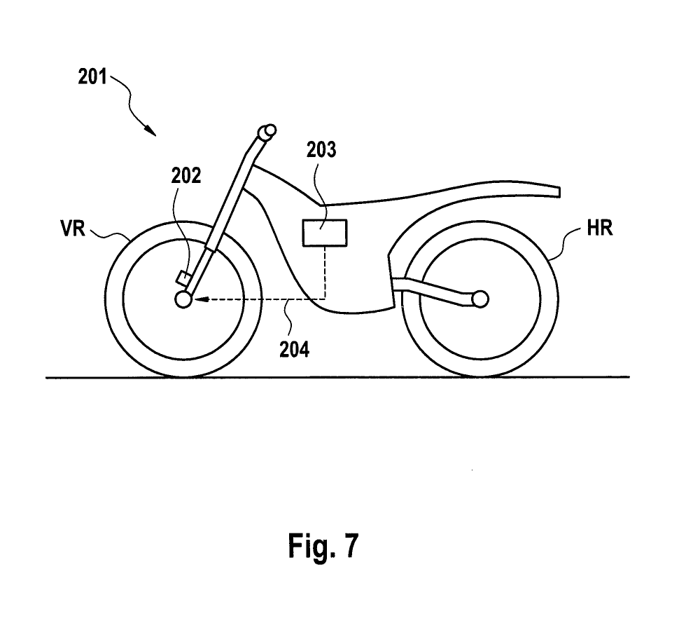

According to the example, the method for determining a vehicle reference speed is implemented in ABS systems for motorcycles, in which (e.g. for cost reasons) only one wheel is anti-locking controlled and thus only one wheel speed sensor is also provided. FIG. 7 shows an example motorcycle in a highly simplified illustration, in which a method according to the invention is advantageously implemented. A wheel revolution rate sensor 202 is arranged at the front wheel VR of the motorcycle 201, whereas the wheel revolution rate of the rear wheel HR is not measured. Motorcycle 201 comprises a brake system with an anti-locking system, which is illustrated purely schematically here by a brake controller 203. The brake system is designed so that ABS slip control can only be carried out on the front wheel VR. This is schematically illustrated in FIG. 7 using the dashed arrow 204 between the brake controller 203 and the front wheel VR.

It is however also advantageous to use the method in distributed brake control systems, in which only the wheel speed information of a wheel is available in a local (wheel-specific) brake control unit. This is, for example, conceivable in an at least partly electromechanical brake system of an automobile, which has a separate brake control unit (WCU: Wheel Control Unit) on at least two wheels, especially on each wheel of the vehicle.

In order to implement higher level driving dynamics and wheel slip control, for example a central brake control unit (ECU: Electronic Control Unit) is used, which has all the wheel speed information available. This central brake control unit ECU transmits pressure or brake force demands in non-fault situations preferably via a bus system to the control units WCU of the individual wheel brakes, so that these local control units do not carry out separate ABS-control in the normal operating case. However, should the central control unit (ECU) or the bus system for data transfer fail, then the control unit (WCU) of each wheel brake can perform local control at a failure-fallback level, if it has the speed signal of its associated wheel available. In this failure fallback mode, local ABS-control is carried out at each wheel brake. The required vehicle reference speed is then defined in the local control unit (WCU) based on the individual wheel speed of the corresponding wheel.

According to the example, the method can also be advantageously implemented in motorcycles, which are fitted with deep tread tires and are mainly operated under off-road conditions. A wheel-specific reference speed can be calculated here in order to prevent under-braking states, even if the motorcycle has a 2-channel control means and two individual wheel speed sensors. In said motorcycles, the problem of under-braking mainly occurs because during braking of an individual wheel the unbraked wheel causes a vehicle reference speed that is too high and the ABS controlled other wheel is thereby stimulated at a slip level that is too low. It is thus advantageous to determine an individual vehicle reference speed for the controlled wheel, which is based on the settling slip level of the controlled wheel following the respective compensation of a tendency towards locking. In order to make sure, in the example it may be required that this individual vehicle reference speed may only lie under the global vehicle reference speed by a predetermined amount, whereby the global vehicle reference speed is determined from both wheel speeds and is based largely on the wheel speed of the unbraked wheel.

According to the example, the method for determining a vehicle reference speed VREF is implemented in an anti-lock system with only one controlled wheel circuit and only one sensor for detecting the speed of this one controlled wheel. In the instability phases of the controlled wheel, in which the wheel is again accelerated to the vehicle speed by pressure decrease and pressure maintenance, a mean vehicle deceleration a_{Fzg} is determined, in that a first signal is formed by strong low-pass filtering of the wheel speed of the wheel involved and additional gradient limiting to a maximum of Ig, and a second signal is formed by weak low-pass filtering of the wheel speed without gradient limiting. The crossing point of these two signals after compensation of the instability of the wheel is then used, together with the speed value of the first signal at the time of identification of the previous wheel instability and this time itself, to form a gradient a_{Fzg}=Δv/ΔT (with Δv=the speed difference of the two speeds and ΔT=the difference of the two times). This mean vehicle deceleration a_{Fzg} is then used to limit the negative gradient of the vehicle reference speed VREF to an anticipated degree of deceleration, wherein the first (strongly filtered and gradient limited) signal is used as the vehicle reference speed VREF itself.

The mean vehicle deceleration a_{Fzg}, which is used for gradient limiting of the vehicle reference speed VREF, is determined again in the example in each instability phase of the wheel according to said method.

In the example, the mean vehicle deceleration a_{Fzg}, which is used for gradient limiting of the vehicle reference speed VREF, is increased for each pressure build-up applied by the ABS control in the stable phases of the wheel by a value that is selected to be proportional to the magnitude of the pressure build-up pulse.

If the controlled wheel is the front wheel of a motorcycle, the mean vehicle deceleration a_{Fzg}, which is used for gradient limiting of the vehicle reference speed VREF, is increased in the example by a suitable amount, if it is recognized from a switch (e.g. a brake light switch or similar), that the driver of the motorcycle has additionally started operating the rear wheel brake circuit while ABS control of the front wheel is already operating.

In another example embodiment, the method is also implemented in motorcycles with 2-channel ABS and having two wheel speed sensors. Here an individual vehicle reference speed VREF is determined for each braked and ABS-controlled wheel, in order that each wheel—especially under extreme conditions (such as off-road surfaces or when using tires with very deep treads)—is controlled to the individual slip level determined as optimal.

A method according to the invention is, however, also implemented in any motor vehicles with local brake controllers in complex brake-by-wire systems, e.g. with electromechanical brakes. Such brake systems comprise a central ABS controller, which in normal operation sends pressure demands via a bus system to the local wheel-specific brake controller. In the event of a failure of the central controller or the bus system, the local controller carries out independent ABS control in a fallback mode using only the speed of the wheel associated with it, whereby the determination of the wheel-specific vehicle reference speed VREF is carried out using a method according to the example.

In the example the anti-lock control is carried out in a digital anti-lock controller, i.e. the controller operates in a time-discrete manner and processes the corresponding variables at fixed, uniform time intervals T (control loop time). For identification of the second working point 8, 10, 48, 104 it is mainly not specified that the two digital signals of the first and second wheel speed signals are exactly equal during a control loop n, even if they overlap when considered in an analog manner.

An intersection point of the first wheel speed signal (vehicle reference speed V_{filt}_{_{—}}_{gradlim}_{_{—}}ₙ or VREFₙ) and the second wheel speed signal (wheel speed or weakly filtered wheel speed vₙ) is then considered to be known in the example in a loop n, if the two signals in loop n are identical:

(1) VREFₙ=vₙ,

or if the second wheel speed signal is below or reaches the first wheel speed signal since the previous loop n−1:

(2) vₙ₋₁>VREFₙ₋₁ and vₙ≦VREFₙ,

or if since the previous loop n−1 the second wheel speed signal exceeds or reaches the first wheel speed signal:

(3) vₙ₋₁<VREFₙ₋₁ and vₙ≧VREFₙ.

Accordingly, the first intersection point at e.g. time 25, at which the second wheel speed signal “intersects from below” the first wheel speed signal, is identified using the above relationship (3). The second intersection point at e.g. time 26, i.e. the second working point 8, at which the second wheel speed signal “intersects from above” or reaches the first wheel speed signal, can be identified using the above relationship (2).

While the above description constitutes the preferred embodiment of the present invention, it will be appreciated that the invention is susceptible to modification, variation and change without departing from the proper scope and fair meaning of the accompanying claims.

1. A method for determining a vehicle reference speed (VREF) in a brake system of a motorized single-track vehicle (201), of a type having an anti-lock control system (203), wherein slip control (204) can be carried out at one wheel (VR) of the motor vehicle depending on the vehicle reference speed (VREF) and having a sensor (202) for measuring wheel speed (v) is arranged on the wheel (VR), comprising the steps of forming a first wheel speed signal (v_{filt}_{_{—}}_{gradlim}) by low-pass filtering of the measured wheel speed (v), wherein the negative gradient of the first wheel speed signal (v_{filt}_{_{—}}_{gradlim}) is limited to a predetermined gradient limit value (Δvₘₐₓ_{_{—}}ₙ/T), and that the first wheel speed signal (v_{filt}_{_{—}}_{gradlim}) is used as a wheel-specific vehicle reference speed (VREF, 3, 42, 62, 102, 110, 122, 123, 142) for slip control of the wheel (VR).

2. The method as claimed in claim 1 further comprising in that a second wheel speed signal (1, 40, 60, 100, 108, 120, 140, 143) is formed, which is compared with the first wheel speed signal (v_{filt}_{_{—}}_{gradlim}, VREF, 3, 42, 62, 102, 110, 122, 123, 142) in order to establish a determined deceleration value (a_{Fzg}), and that the gradient limit value (Δvₘₐₓ_{_{—}}ₙ/T) is adapted depending on the determined deceleration value (a_{Fzg}), wherein the gradient limit value (Δvₘₐₓ_{_{—}}ₙ/T) is selected to be equal to the determined deceleration value (a_{Fzg}).

3. The method as claimed in claim 2, further comprising in that the second wheel speed signal (1, 40, 60, 100, 108, 120, 140) corresponds to an unfiltered signal of the measured wheel speed (v) or that the second wheel speed signal (143) is formed by low-pass filtering of the measured wheel speed (v) with a filter constant which is smaller than a filter constant of the low-pass filtering of the first wheel speed signal (v_{filt}_{_{—}}_{gradlim}).

4. The method as claimed in claim 2 further comprising in that the determined deceleration value (a_{Fzg}) is determined from a time period (ΔT) and an associated speed difference (Δv) of the first wheel speed signal (v_{filt}_{_{—}}_{gradlim}, VREF, 3, 42, 62, 102, 110, 122, 123, 142).

5. The method as claimed in claim 4, further comprising in that the time period (ΔT) is determined by a time interval between a first (7, 9, 47, 103, 111) and a second (8, 10, 48, 104, 112) operating point and the speed difference (Δv) is determined as the speed change of the first wheel speed signal (3, 42, 102, 110) between the first and second operating points, wherein the first operating point (7, 9, 47, 103, 111) is identified if a wheel instability of the wheel (VR) is identified if the slip of the wheel (VR) exceeds a slip threshold or if a pressure decrease at the wheel (VR) is carried out by the anti-lock control system.

6. The method as claimed in claim 5, further comprising in that the second operating point (8, 10, 48, 104) is identified if the second wheel speed signal (1, 40, 100) decreases and the second wheel speed signal intersects the first wheel speed signal (3, 42, 102).

7. The method as claimed in claim 5, further comprising in that the associated second operating point (112) is identified if the first (110) and the second (108) wheel speed signals differ by no more than a predetermined amount for a predetermined time period (ΔT_{sd}).

8. The method as claimed in any one of claim 1 further comprising in that during a pressure build-up phase of the anti-lock control of the wheel (VR), the predetermined gradient limit value (Δvₘₐₓ_{_{—}}ₙ/T) is increased by an amount (Δa_{Fzg}), which is proportional to the pressure increase (ΔP) at the wheel (VR) in the pressure build-up phase.

9. The method as claimed in claim 1 further comprising in that the gradient limit value (Δvₘₐₓ_{_{—}}ₙ/T) for limiting the first wheel speed signal of the slip-controlled wheel (VR) is adapted depending on a signal (HR-BLS) of a brake light switch for a different wheel (HR) than the slip-controlled wheel (VR), being increased or reduced by a predetermined percentage amount.

10. A brake system of a single-track motor vehicle (201) with an anti-lock control system, which comprises a brake controller (203) for slip control (204) of a wheel (VR) of the motor vehicle and a sensor (202) for measuring the wheel speed (v) of the slip-regulated wheel (VR), wherein a vehicle reference speed (VREF) for slip control of the wheel (VR) is determined in the brake controller (203), the brake controller configured for determining a wheel-specific vehicle reference speed (VREF) in that a first wheel speed signal (v_{filt}_{_{—}}_{gradlim}) is determined by low-pass filtering of the measured wheel speed (v), wherein a negative gradient of the first wheel seed signal (V_{filt}_{_{—}}_{gradlim}) is limited to a predetermined gradient limit value (Δvₘₐₓ_{_{—}}ₙ/T) and that the first wheel speed signal (V_{filt}_{_{—}}_{gradlim}) is used as a wheel-specific vehicle reference speed (VREF, 3, 42, 62, 102, 110, 122, 123, 142) for slip control of the wheel (VR).

11. The brake system of a single-track motor vehicle (201) as claimed in claim 10, further comprising in that the system it is designed so that the slip control is only implemented on only the front wheel of the vehicle, and only comprises a single sensor (202) for measuring the wheel speed (v) of the vehicle of the front wheel (VR).

12. The brake system of a single-track motor vehicle (201) as claimed in claim 10, further comprising in that the system is designed so that slip control can be implemented on both wheels (VR, HR) of the vehicle, wherein a sensor (202) for measuring the wheel speed (v) is arranged on each of the two wheels, and a wheel-specific vehicle reference speed (VREF) is determined in the brake controller (203) for each of the two wheels (VR, HR), wherein in pre-determined situations, the brake controller (203) carries out slip control on each of the two wheels (VR, HR) depending on the respective wheel-specific vehicle reference speed (VREF).

13. The brake system of a single-track motor vehicle as claimed in claim 10, with electromechanical brakes, the central brake controller acting on all wheels of the motor vehicle depending on a global vehicle reference speed, which is determined using the wheel speed signals of all wheels, and having wheel-specific brake controllers, each being associated with one of the wheels, wherein in a failure case of the brake system, each of the wheel-specific brake controllers determines a wheel-specific vehicle reference speed (VREF) for its associated wheel and implements slip control of its associated wheel depending on the wheel-specific vehicle reference speed (VREF).
